(19) United States
(12) Patent Application Publication
(10) Pub. No.: US 2026/0116678 A1
(43) Pub. Date: Apr. 30, 2026

(54) CONTAINER FOR USE IN HANDLING BULK MATERIALS

(71) Applicant: Container Rotation Systems Pty Ltd, Hornsby (AU)

(72) Inventor: Murray Robert Bridle, Wetherill Park (AU)

(21) Appl. No.: 19/375,166

(22) Filed: Oct. 30, 2025

(30) Foreign Application Priority Data
Oct. 30, 2024 (AU) 2024903531

(51) Int. Cl. B65G 65/23; B65D 88/12; B65D 90/00

(52) U.S. Cl. CPC B65G 65/23; B65D 88/121; B65D 90/0033

(57) ABSTRACT

A container for use in handling bulk materials is described including: a substantially rectangular container frame comprising: a pair of bottom end rails; a pair of top end rails; a pair of top side rails; a pair of bottom side rails; the pairs of rails are joined at the upper and lower regions of four corner posts; a floor panel; and a pair of end panels; the container additionally includes a pair of side members, the side members extend outwardly of the sides of the frame to define an internal space in the container in which bulk material can be contained which is larger than the volume of the container frame; and a series stiffening ribs are provided on the inside surface of the side members.

### TECHNICAL FIELD

The present invention relates to containers used in handling bulk materials and particularly relates to containers used in loading operations of bulk materials.

### BACKGROUND TO THE INVENTION

There is a growing use of container rotating systems in the field of bulk cargo handling operations. In these systems, a set of containers is used along with a container rotating device, particularly in operations to load bulk material into the hull of a ship. In these operations the container rotating device is suspended from a dockside crane and is controlled by a control system that is operated by the dockside crane operator.

The container rotating device is used to grasp filled containers in turn, bring them over the loading hatch of the hull of a ship, and then rotate the container to tip the contents of the container into the hold of the ship.

The invention is aimed at improving the throughput of these systems, to make them faster and more efficient at handling bulk materials.

### SUMMARY OF THE INVENTION

In a first aspect the present invention provides a container for use in handling bulk materials including: a substantially rectangular container frame comprising: a pair of bottom end rails; a pair of top end rails; a pair of top side rails; a pair of bottom side rails; the pairs of rails are joined at the upper and lower regions of four corner posts; a floor panel; and a pair of end panels; the container additionally includes a pair of side members, the side members extend outwardly of the sides of the frame to define an internal space in the container in which bulk material can be contained which is larger than the volume of the container frame; and a series stiffening ribs are provided on the inside surface of the side members.

The stiffening ribs may be oriented vertically.

The stiffening ribs may include cut out holes.

The side members may attach to the container frame about their peripheral regions.

The peripheral region of each side member may surround a central region which extends away from the plane of the peripheral region to create a storage space in the side member.

The central region may include a planar region which lies in a plane that is parallel to the plane of the periphery of the side member.

The top corner regions of the container may include formations to enable the container to be grasped and lifted by a lifting device.

The container frame may have dimensions corresponding to a standard ISO container size.

In a second aspect the invention provides a combination of a container rotating device and a container according to the first aspect of the invention.

### BRIEF DESCRIPTION OF THE DRAWINGS

An embodiment of the present invention will now be described, by way of example only, with reference to the accompanying drawings, in which:

FIG. 1 is a perspective view of a container being used with a container rotation device;

FIG. 2 is a top view of a container;

FIG. 3 is a side view of the container of FIG. 2;

FIG. 4 is an end view of the container of FIG. 2;

FIG. 5 is a cross sectional view along the line A-A of FIG. 2;

FIG. 6 is a cross sectional view along the line B-B of FIG. 3; and

FIG. 7 is a cross sectional view along the line C-C of FIG. 3.

### DETAILED DESCRIPTION OF THE PREFERRED EMBODIMENT

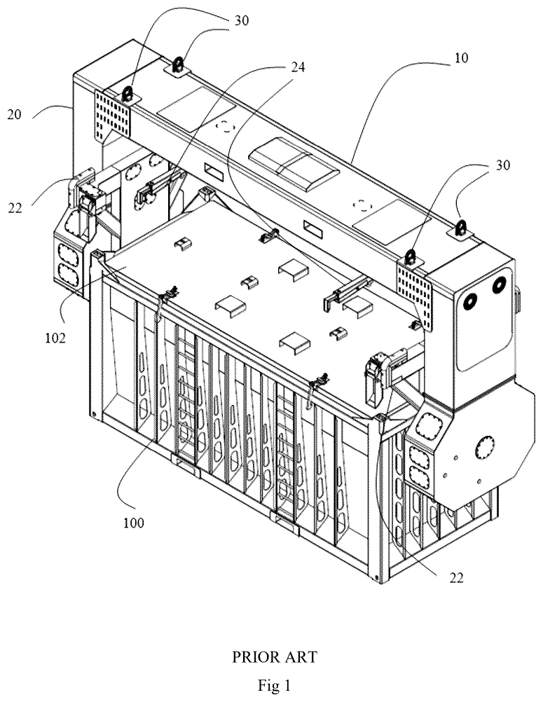

Referring to FIG. 1, a cargo container rotating apparatus 10 for handling cargo prior art containers 100 with lids 102 is shown. The apparatus 10 is sold under the trade mark ROTAINER® by Container Rotation Solutions Pty Ltd (www.rotainer.com). Apparatus 10 includes a main body 20 and a container engagement arrangement for engaging with a cargo container in the form of two arms 22, each of which are pivotally mounted to body 20 and are each fitted with a pair of twist locks for engaging with twist lock pockets provided at the top corners of the container 100 in a known fashion. The arms 22 are associated with hydraulic actuators (not visible) which can be operated to rotate the arms with respect to the body 20.

Apparatus 10 further includes a container lid lifting mechanism in the form of lid lifting assemblies 24 which are associated with the body for engaging with a lid 102 of the container 100 and are also associated with hydraulic actuators which are arranged to move the lid lifting assemblies 24 between a raised position and a lowered position to thereby move the lid of the container between a closed condition and an open condition as will be later described.

Body 10 is attachable to a lifting device in the form of a dockside crane by way of attaching chains to eyelets 30 so that the combination of the handling apparatus 10 container 100 and lid 102 may be lifted off the ground and moved to different locations in an area.

The cargo handling apparatus known as ROTAINER® is typically used for loading operations. In these operations the cargo handling apparatus is suspended from a dockside crane and is controlled by a control system that is operated by the dockside crane operator. The apparatus is brought into proximity with a loaded container and attached to the container by way of operating the twist locks provided on arms 22. The combination of the apparatus and container is then lifted by the crane and moved to a position where the container is suspended above the loading hatch of a ship's hold. The crane operator then initiates a sequence of operations to 1) lift the lid of the container; and 2) rotate the container by way of the rotating arms 22 to invert the container so that the material in the container drops from the open container into the hold. The container is then returned to its upright position, the lid replaced, and the empty container is set down on the dockside for subsequent re-use.

In some implementations, the containers may not have lids, and the container rotating device may not have a lid lifting mechanism.

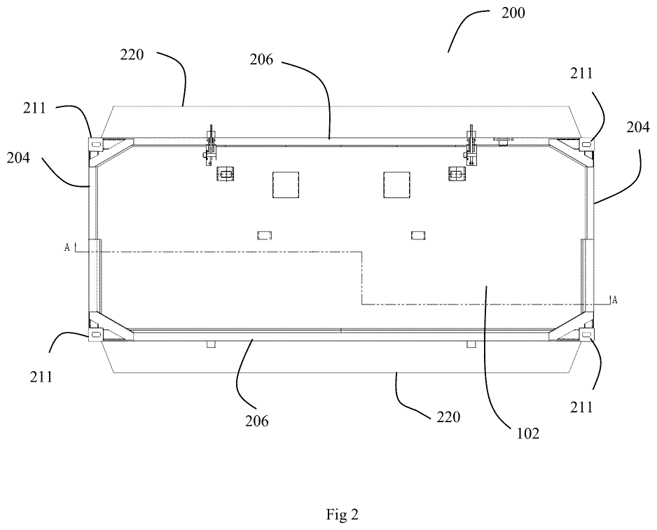

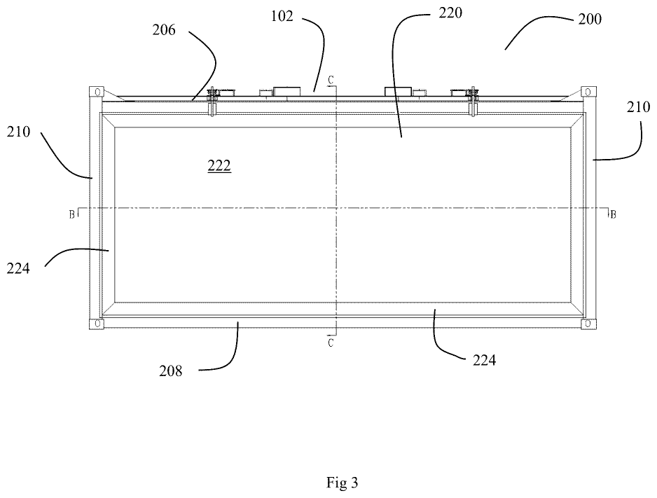

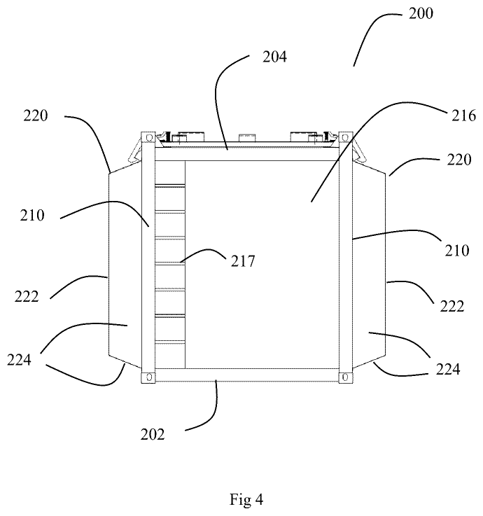

Referring now to FIGS. 2 to 7, a novel container 200 for use in handling bulk materials in conjunction with a container rotating device are shown. Container 200 is constructed by firstly assembling a substantially rectangular container frame comprising a pair of bottom end rails 202; a pair of top end rails 204; a pair of top side rails 206; a pair of bottom side rails 208. The pairs of rails 202, 204, 206, 208 are joined by welded joints at the upper and lower regions of four corner posts 210.

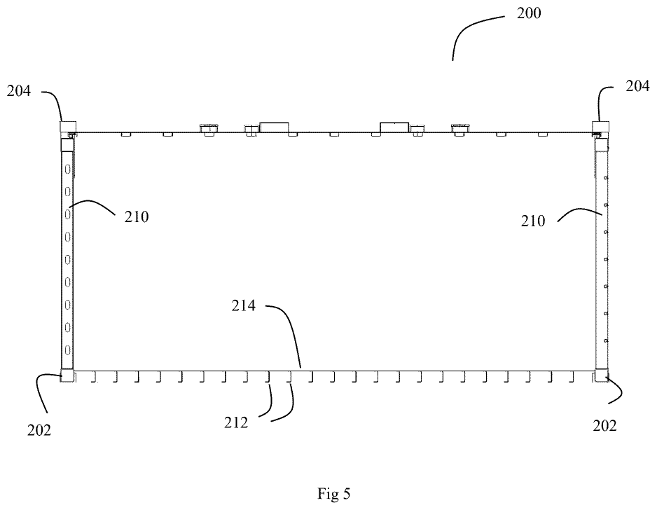

A twist lock pocket formation 211 is provided at the upper end of each of the corner posts 210. As best seen in FIG. 5, a series of floor joists 212 are welded between the lower side rails 212. The container frame has dimensions corresponding to a standard ISO container size. A metal floor panel 214 is laid over the joists 212 and welded in place.

A pair of end panels 216 are welded in place at each end of the container. A ladder 217 is provided at each end panel 216 to allow personnel to access the top region of the container 200.

The container 200 additionally includes a pair of side members 220. The side members 220 are welded to the container frame about their peripheries. All of the components used to fabricate the container are formed from mild steel.

The panels 220 include a planar region 222 which is formed from corrugated metal and is spaced away from the peripheral region by four angled plates 224 to create a storage space in the side member. The side panels 220 are fabricated by welding plates 224 to the planar region 222. The outer edges of the plates 224 form the peripheral region of the side member and are welded to the frame.

The side members 220 extend outwardly on either side of the frame to define an internal space in the container in which bulk material can be contained which is larger than the volume of the container frame. In the embodiment shown, an increase in volume of 60% has been achieved when compared with the volume of the rectangular ISO frame.

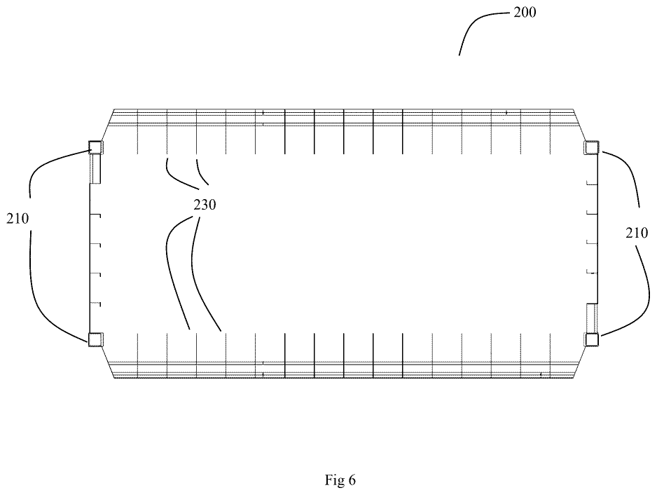

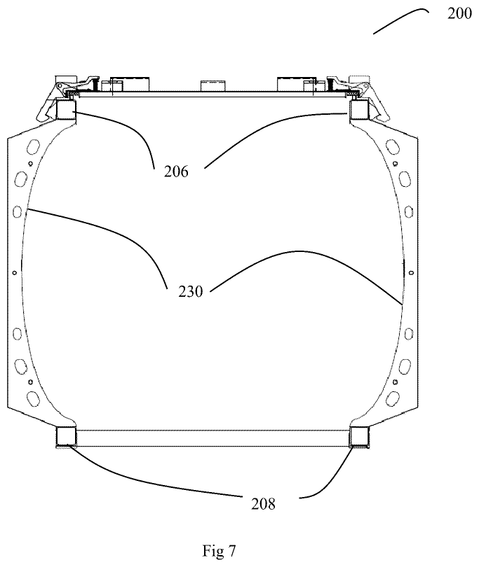

Referring to FIGS. 6 and 7, a series stiffening ribs 230 are provided on the inside surface of the side members 220. The stiffening ribs extend from the floor to the roof of the container and conform with the inside surface of the side member 220. The stiffening ribs are welded in place along their length and at their ends to the top side rails 206 and the bottom side rails 208. The stiffening ribs include cut out holes to save weight.

Container 200 also includes a removable lid 102 of the same construction as seen in FIG. 1 and is intended for use with container rotating devices of the type 10 seen in FIG. 1.

Containers 200 is particularly suitable for loading bulk materials of relatively low density such as grains, wood chips, or other pulp products. In the case of grain loading, a set of containers 200 might be used at a grain storage facility to transport grain to a nearby loading dock by rail or road. At the loading dock, the loaded containers are grasped by a container rotating device at the top corners of the container which is used to lift the container and tip out the contents of the containers into the hold of a ship. The empty containers are then returned to the grain storage facility for refilling.

The container 200 is of a larger volume than a standard ISO size container to achieve greater volume of throughput for each container rotating operation. The stiffening ribs 230 add strength to the container to maintain the integrity of the container during a tipping operation. When the container is rotated about its long axis, the material in the container slides out between the stiffening ribs which do not obstruct the material being tipped out of the container.

It can be seen that embodiments of the invention have at least one of the following advantages:
Volume of containers used with cargo rotating devices is increased thus allowing for increased payload for each operation of the device, increasing the rate of material throughput.

Any reference to prior art contained herein is not to be taken as an admission that the information is common general knowledge, unless otherwise indicated.

Finally, it is to be appreciated that various alterations or additions may be made to the parts previously described without departing from the spirit or ambit of the present invention.

1. A container for use in handling bulk materials including:
a substantially rectangular container frame comprising:
a pair of bottom end rails;
a pair of top end rails;
a pair of top side rails;
a pair of bottom side rails;
the pairs of rails are joined at the upper and lower regions of four corner posts;
a floor panel; and
a pair of end panels;
the container additionally includes a pair of side members, the side members extend outwardly of the sides of the frame to define an internal space in the container in which bulk material can be contained which is larger than the volume of the container frame; and
a series stiffening ribs are provided on the inside surface of the side members.

2. A container according to claim 1 wherein the stiffening ribs are oriented vertically.

3. The container according to claims 1, wherein the stiffening ribs include cut out holes.

4. The container according to claim 1, wherein the side members attach to the container frame about their peripheral regions.

5. The container according to claim 1, wherein the peripheral region of each side members surrounds a central region which extends away from the plane of the peripheral region to create a storage space in the side member.

6. A container according to claim 5 wherein the central region includes a planar region which lies in a plane that is parallel to the plane of the periphery of the side member.

7. The container according to claim 1, wherein the top corner regions of the container include formations to enable the container to be grasped and lifted by a lifting device.

8. The container according to claim 1, wherein the container frame has dimensions corresponding to a standard ISO container size.

9. The container according to claim 1, further comprising:
a container rotating device.
